(19) United States
(12) Patent Application Publication
(10) Pub. No.: US 2007/0044779 A1
(43) Pub. Date: Mar. 1, 2007

(54) Apparatus for the multiplication of air flow in internal combustion engines increasing horsepower and torque, while reducing emissions

(76) Inventor: Carl Anson Green, Branson, MO (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/276,968

(22) Filed: Mar. 20, 2006

Related U.S. Application Data
(60) Provisional application No. 60/594,218, filed on Mar. 20, 2005.

(51) Int. Cl. F02B 23/00; F02M 35/02

(52) U.S. Cl. 123/585; 123/198 E

(57) ABSTRACT

Compressed air is fed from a pressurized reservoir (5) thru a nozzle/vortex unit (1) simultaneously drawing ambient air through an air filter element (10). The air mixes in a merging plenum (7) where air-charge multiplication occurs resulting in boost or positive pressure conditions. The positive pressure introduced to the intake air of the engine results in a higher cylinder combustion compression ratio. The increase compression ratio with proper air to fuel ratio results in an increase in horsepower and torque. Air is controlled by a computer (6), regulators, solenoids, micro-switches, and nozzle configurations. Air is supplied via reservoir (5) and replenished from mechanical or electric air pumps (FIG. 3 18s, 18b, 18c, 18d). Alternative fuels/gases can be added such as nitrous oxide or propane (3, 4). In diesel engine applications (FIG. 3), the power and torque increases can also be experienced, but also reduce emission levels at low rpm or idle mode conditions.

### CROSS REFERENCE TO RELATED APPLICATIONS

This application claims the benefit of Provisional Application No. 60/594,218, filed on Mar. 20, 2005.

### BACKGROUND OF THE INVENTION

This invention relates generally to the field of motor vehicles and more specifically to an apparatus for the multiplication of air flow in internal combustion engines increasing horsepower and torque, while reducing emissions.

The use of increasing intake air on internal combustion engines has been identified to be a very effective way to improve combustion burn rates and efficiencies. Raising the intake air-charge to a “boost” or positive pressure condition is the most effective and dependable way to result in horsepower and torque gains that are not typical to naturally aspirated engines.

Previous technologies have been able to “boost” or positive pressure through complex apparatuses. Turbo-charging requires to be driven from exhaust gas pressures, and super-charging requires to be driven from the crank-shaft of the engine. Both prior technologies raise the intake air to a “boost” or positive pressure condition. The new technology of this patent is equally effective in increasing “boost” or positive pressure conditions as prior technologies, but in a simplified method.

There are many improvements that will be accomplished through this new technology that are significant problems in previous technologies. Turbo-charging requires high exhaust gas pressure in order to start producing “boost” or positive intake air pressure. This problematic area with turbo-charging is referred to as “turbo lag” or “spooling lag”. Turbo-charging also generates a back up or retention of heat from the need to create back pressure for driving the turbo-charging device. This results in higher under-hood temperatures and often higher intake air temperatures. Super-charging has a more direct relationship to crank-shaft rpm and often requires more rpm for more “boost” or positive air pressure. The only way to accomplish full efficiency in super-charging is either high crank-shaft speeds or multiplied gearing in the super-charger such as 2 to 1 of the crank-shaft speed. In both prior technologies the driving mechanisms result in losses from the original engine torque that need to be overcome prior to net increases in output. Both prior technologies have complex designs that contain many moving parts, wearing surfaces, complicated manufacturing processes, and high warranty or maintenance costs related. This new technology can also be used with turbo-charging as a method to correct the issues with “turbo lag” or “spooling lag”. This lag scenario is the leading cause of low rpm or idle-mode emission problems with current diesel engine operation. This technology is a viable option to creating “boost” or positive air intake pressure while the turbo-charger is off “boost” due to low exhaust gas pressures.

### BRIEF SUMMARY OF THE INVENTION

The primary object of the invention is to provide increased air flow with no moving parts involved. Another object of the invention is to provide increased air flow with no wearing surfaces. Another object of the invention is to provide increased airflow with a lower cost per unit. Yet another object of the invention is to provide increased air flow with a lower installation time per vehicle. Still yet another object of the invention is to provide increased air flow where malfunction cannot cause vehicle to be non-operational. Another object of the invention is to provide increased air flow with a lower warranty or replacement cost. Another object of the invention is to provide increased air flow with more versatility in vehicle mounting location. A further object of the invention is to provide increased air flow with no increase in under-hood temperatures. Yet another object of the invention is to provide increased air flow with more value-added economics per vehicle.

Other objects and advantages of the present invention will become apparent from the following descriptions, taken in conjunction with the accompanying drawings, wherein, by way of illustration and example, an embodiment of the present invention is disclosed.

In accordance with a preferred embodiment of the invention, an apparatus to effectively and reliably increase the total volume of air supplied to an internal combustion engine. In accordance with a preferred embodiment of the invention, an apparatus that effectively and reliably increases horsepower and torque in an internal combustion engine. In accordance with a preferred embodiment of the invention, an apparatus that can introduce alternative fuels or gases into the induction air stream. In accordance with a preferred embodiment of the invention, an apparatus that can effectively reduce emission levels in diesel engines.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross-section/plan view of the base technology;

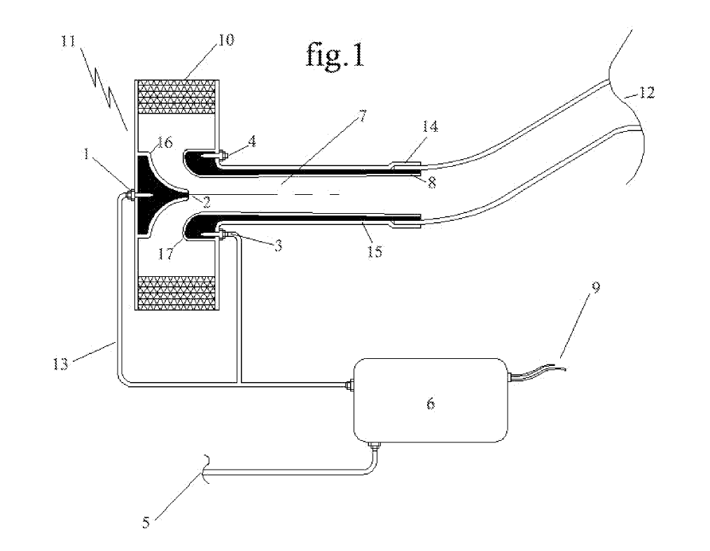

FIG. 2 is a cross-section/plan view with alternative geometric configuration of the base technology;

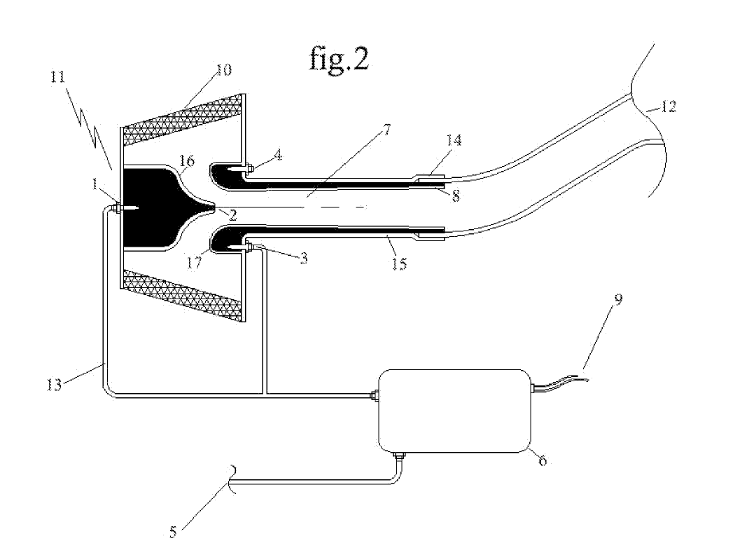

FIG. 3 is a cross-section/plan view of the base technology with internal combustion engine and compressed air supply options; and

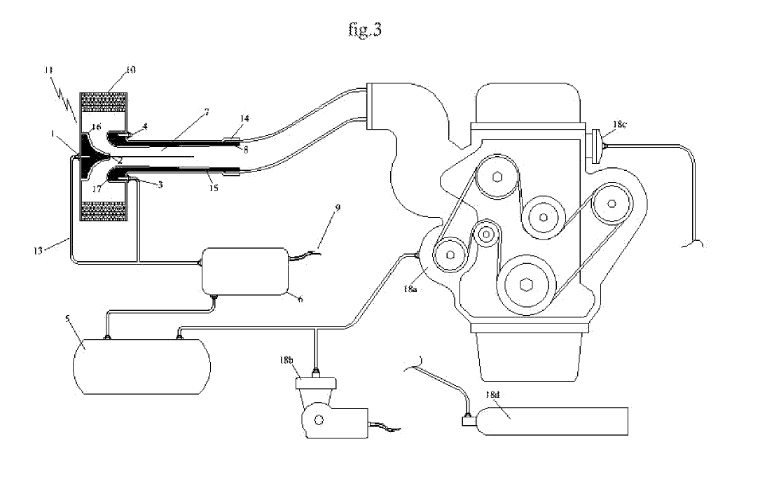

FIG. 4 is a cross-section/plan view of the base technology in multiple arrangement.

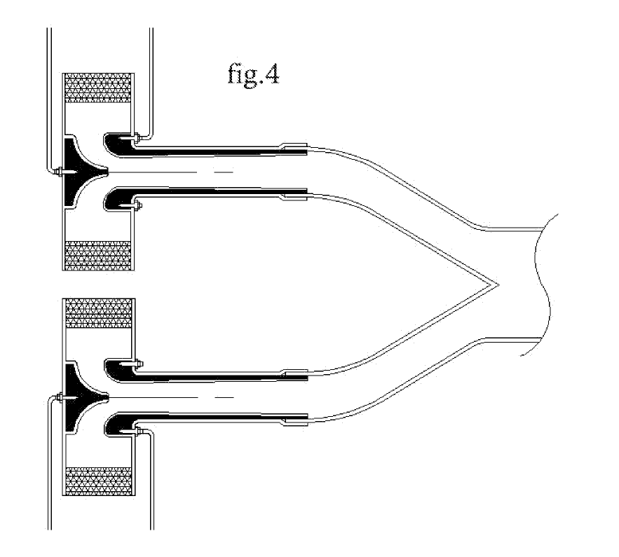

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. The invention having:

(1) a nozzle for calibrating and dispensing compressed air that is unique in geometric shape;

(2) a housing chamber to introduce compressed air through a vortex nozzle passage that is unique in geometric shape;

(3) a tube for transporting alternative fuel or gases that is current fuel/gas delivery plumbing technology;

(4) a nozzle for calibrating alternative fuel or gases that is unique in geometric shape

(5) a source or reservoir to hold/supply compressed air that is current reservoir technology;

(6) a control device for metering compressed air using existing electronic control technology;

(7) a geometrical shape of housing chamber that is new unique technology;

(8) a flux capacitor that accelerates air flow that is a new unique geometrical shape;

(9) an input signal for compressed air control device that is current electronic technology;

(10) an air filtration element cleansing atmospheric air that is current air filtration technology;

(11) an air-charge multiplication housing is a new unique geometrical shape;

(12) intake ducting for internal combustion engine that is current existing intake ducting technology;

(13) a tube for transporting compressed air is current fuel/gas delivery plumbing technology;

(14) adaptation of the connection with intake ducting for internal combustion engine based on current technology;

(15) air-charge multiplier housing that is a new unique geometrical shape;

(16) outer lead-in transition shape to merge point is a new unique geometrical shape;

(17) inner lead-in transition shape to merge point is a new unique geometrical shape;

(18a) engine mounted air compressor to supply compressed air based on existing technology;

(18b) electric air compressor to supply compressed air based on existing technology;

(18c) diaphragm pump operating from combustion pulses to supply compressed air based on new technology; and

(18d) a stand-alone compressed air container based on current compressed air storage technology.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

I claim:

1. An apparatus for the multiplication of air flow in internal combustion engines increasing horsepower and torque, while reducing emissions comprising:
(a) a merging plenum where compressed air and ambient are combined together increasing air flow volume up to but not limited to 10 times the naturally aspirated air flow;
(b) wherein multiple merging plenums allow for large air flow volume increases up to but not limited to 50 times the naturally aspirated air flow;
(c) wherein increased air flow volume creates a “boost” or positive pressure condition in the internal combustion engine intake charge;
(d) wherein multiplied air flow volume allows for increased effectiveness in alternative fuel mixing through axillary nozzle locations; and
(e) wherein multiplied air flow volume will reduce emissions in diesel engine applications with or without turbo-charger original manufactured equipment.
